(19) United States
(12) Patent Application Publication
(10) Pub. No.: US 2014/0014736 A1
(43) Pub. Date: Jan. 16, 2014

(54) AROMA-DIFFUSING HEATING DEVICE USING A REPLACEABLE AROMA CAPSULE AND THE AROMA CAPSULE

(71) Applicant: Peter WIRZ, Luzern (CH)

(72) Inventor: Peter WIRZ, Luzern (CH)

(21) Appl. No.: 13/549,493

(22) Filed: Jul. 15, 2012

(51) Int. Cl. B05B 1/24

(52) U.S. Cl. 239/135

(57) ABSTRACT

An aroma-diffusing heating device includes a heating base, an aroma capsule detachably accommodated in the heating base and heatable by the heating base to give off fragrance, and a cap capped on the heating base over the aroma capsule. The aroma capsule includes a heat-transfer container defining a top opening, an essential oil held in the heat-transfer container, an absorptive material put in the heat-transfer container to absorb the essential oil, and a sealing film bonded to the heat-transfer container to seal the essential oil and the absorptive material in the heat-transfer container.

### FIELD OF THE INVENTION

The present invention relates to scent releasing devices and more specifically, to an aroma-diffusing heating device that uses a replaceable aroma capsule. The invention relates also to the aroma capsule.

### DESCRIPTION OF THE RELATED ART

In modern society, in order to remove the smell in the air, or to enrich the spice of life, many people started using fragrance products (for example, essential oils). When in use, a user needs to remove the essential oil from the essential oil container and put it in an accommodation chamber in a heater, and then electrically conduct the heater to heat the essential oil, causing the essential oil to give off fragrance.

The aforesaid application method has drawbacks. During application, the user must remove the essential oil from the essential oil container and then put the essential oil in the accommodation chamber in the heater carefully, avoiding direct contact of the hands with the essential oil. After the essential oil having been put in the accommodation chamber in the heater, the essential oil may be forced out of the heater accidentally upon an impact. Further, after the essential oil in the accommodation chamber in the heater is used up, the user needs to clean the accommodation chamber. If the accommodation chamber is not cleaned after each use, a new supply of essential oil will be mixed with the residual essential oil in the accommodation chamber, giving a bad smell. Further, if the accommodation chamber is formed of a fragile material (for example, ceramics), it may be broken easily during cleaning.

Therefore, it is desirable to provide an aroma-diffusing design that eliminates the drawbacks of the aforesaid prior art design.

### SUMMARY OF THE INVENTION

The present invention has been accomplished under the circumstances in view. It is therefore the main object of the present invention to provide an aroma-diffusing heating device, which is configured to heat an aroma capsule to give off fragrance, wherein the aroma capsule is replaceable with a new one when used up.

To achieve this and other objects of the present invention, an aroma-diffusing heating device comprises a heating base defining a top accommodation open chamber, an aroma capsule detachably accommodated in the top accommodation open chamber of the heating base and heatable by the heating base to give off fragrance, and a cap capped on the heating base over the aroma capsule. The aroma capsule includes a heat-transfer container defining a top opening, an essential oil held in the heat-transfer container, an absorptive material put in the heat-transfer container to absorb the essential oil, and a sealing film bonded to the heat-transfer container to seal the essential oil and the absorptive material in the heat-transfer container.

Further, the aroma capsule is configured to fit the shape of the top accommodation open chamber of the heating base.

Further, the heating base comprises an inwardly curved and tapered top surface disposed around the top accommodation open chamber and connected to the periphery of the top accommodation open chamber.

Further, the heat-transfer container of the aroma capsule comprises a rim extending around the top opening. Further, the rim can be designed to extend horizontally in a parallel manner relative to the top opening of the heat-transfer container, or in a perpendicular manner relative to the top opening of the heat-transfer container.

The invention also provides an aroma capsule for placing in a top accommodation open chamber of a heating base of an aroma-diffusing heating device and heatable by the heating base to give off fragrance. The aroma capsule comprises a heat-transfer container defining a top opening, an essential oil held in the heat-transfer container, and absorptive material put in the heat-transfer container to absorb the essential oil, and a sealing film bonded to the heat-transfer container to seal the essential oil and the absorptive material in the heat-transfer container.

### BRIEF DESCRIPTION OF THE DRAWINGS

FIG. 1 is an exploded view of a heating device in accordance with the present invention.

FIG. 2 is an exploded view of the aroma capsule of the heating device in accordance with the present invention.

FIG. 3 is a sectional side view of FIG. 2.

### DETAILED DESCRIPTION OF THE PREFERRED EMBODIMENT

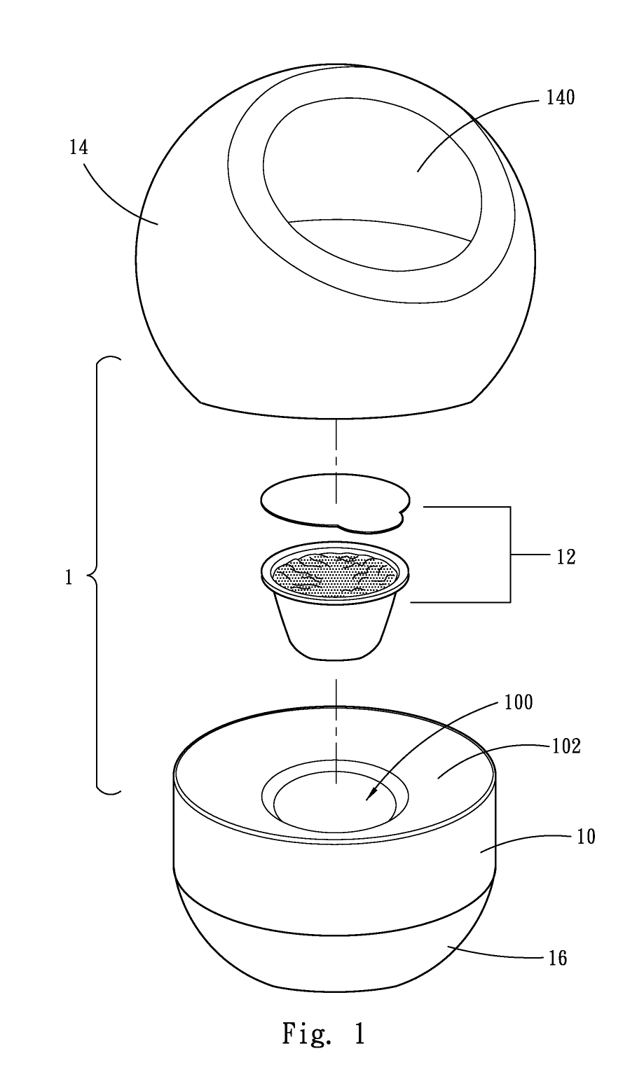

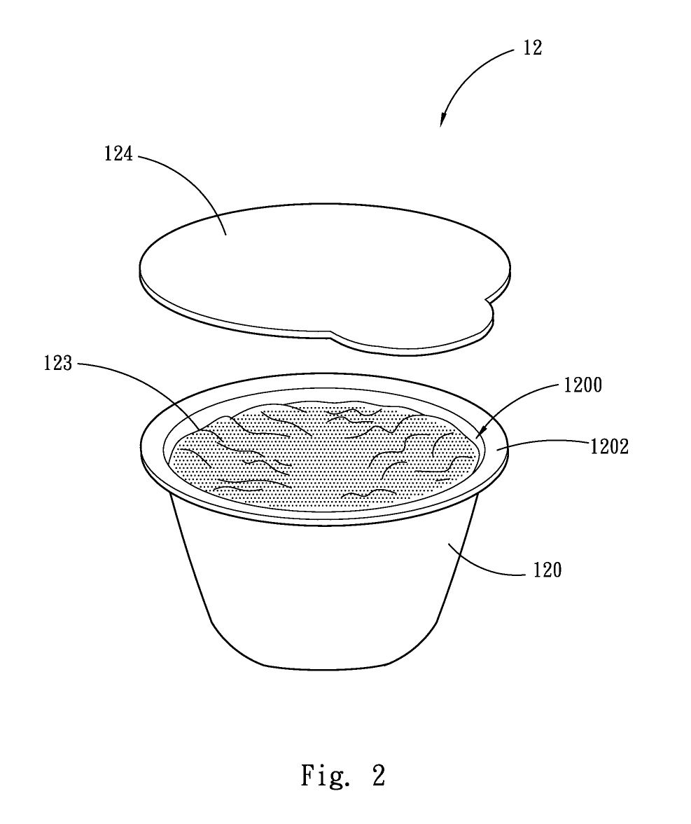

Referring to FIGS. 1-3, an aroma-diffusing heating device 1 in accordance with the present invention is shown having an aroma capsule 12 therein. The aroma-diffusing heating device 1 comprises a ceramic bowl 16, a heating base 10 supported on the ceramic bowl 16 and defining a top accommodation open chamber 100 that accommodates the aroma capsule 12, and a cap 14 capped on the heating base 10 over the aroma capsule 12.

The aroma capsule 12 comprises a heat-transfer container 120 kept in contact with the heating base 10 and defining a top opening 1200, an essential oil 122 (or aroma or perfume) put in the heat-transfer container 120, an absorptive material 123 having open spaces therein and put in the heat-transfer container 120 to absorb the essential oil 122, and a sealing film 124 bonded to the heat-transfer container 120 to seal the essential oil 122 and the absorptive material 123 in the heat-transfer container 120, maintaining the quality of the essential oil 122.

During application, the user simply needs to remove the sealing film 124 from the rim 1202 of the heat-transfer container 120 and then electrically conducting the heating base 10 to heat the essential oil 122, causing the essential oil 122 to give off fragrance that goes out of open spaces in the absorptive material 123 into the outside open air.

According to the present invention, the heating base 10 is configured to heat the essential oil 122 to about 40-70° C., or preferably 50-55° C. Within this temperature range, commercial essential oils can give off fragrance without destroying the quality. Further, under this temperature range of 40-70° C., the heat-transfer container 120 is maintained intact and can effectively transfer heat from the heating base 10 to the essential oil 122. The heat-transfer container 120 can be selected from the material group of ceramics, metals, and hard plastics. Preferably, the heat-transfer container 120 is made from a light metal, for example, aluminum foil for the advantages of light weight, high toughness and high thermal conductivity, avoiding the disadvantage of high fragileness of pottery bowls and glass containers. Further, the sealing film 124 seals the essential oil 122 and the absorptive material 123 in the top opening 1200, maintaining the quality of the essential oil 122.

Further, the absorptive material 123 can be selected from the material group of foam, sponge, porous ceramics, gypsum and fibers. The open spaces in the absorptive material 123 can absorb the essential oil 122 and release essential oil molecules during heating. If the aroma-diffusing heating device 1 falls to the floor accidentally, the absorptive material 123 can retain the essential oil 122, avoiding splashing, fire accidents or environmental pollution.

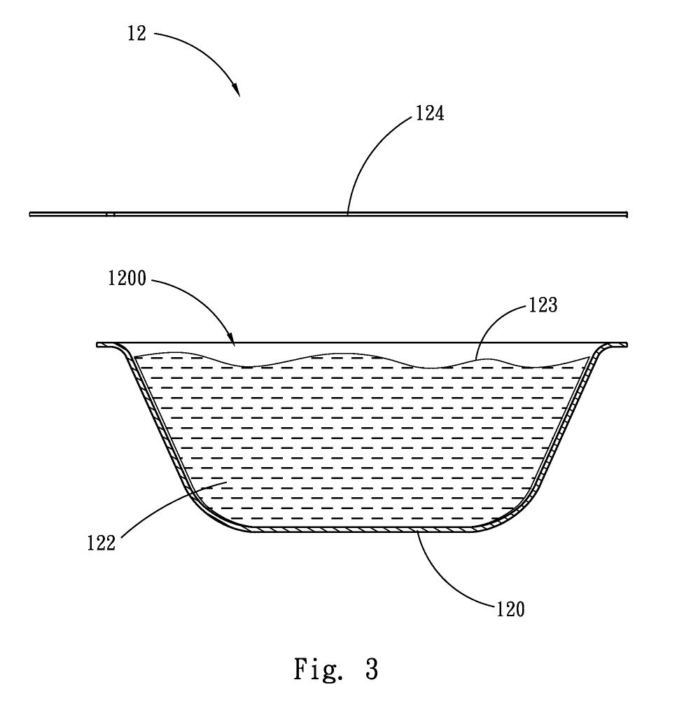

Referring to the cross-sectional view of the aroma capsule 12 shown in FIG. 3, as stated above, the essential oil 122 is sealed in the aroma capsule 12 and the aroma capsule 12 is accommodated in the top accommodation open chamber 100 of the heating base 10 of the aroma-diffusing heating device 1. When using the aroma-diffusing heating device 1, the user simply needs to remove the sealing film 124 from the heat-transfer container 120 without contacting the essential oil 122. Further, after the essential oil 122 is used up, the user can put a new aroma capsule in the top accommodation open chamber 100 of the heating base 10 of the aroma-diffusing heating device 1 as a substitute and needs not to wash the heat-transfer container 120 of the used aroma capsule 12. Further, because the user does not need to clean the heat-transfer container 120, the user needs not to worry about breaking down the heat-transfer container 120. Further, the user needs not to prepare a container for holding essential oil. Further, because the essential oil 122 is absorbed by the absorptive material 123 in the heat-transfer container 120, the essential oil 122 will not leak out of the heat-transfer container 120 after removal of the sealing film 124 from the heat-transfer container 120.

Further, the heat-transfer container 120 is configured to fit the shape of the top accommodation open chamber 100 of the heating base 10 of the aroma-diffusing heating device 1 so that the heat-transfer container 120 can be kept in close contact with the periphery of the top accommodation open chamber 100 of the heating base 10 of the aroma-diffusing heating device 1 to transfer heat energy from the heating base 10 to the essential oil 122 rapidly.

Further, the heating base 10 has an inwardly curved and tapered top surface 102 disposed around the top accommodation open chamber 100 and connected to the periphery of the top accommodation open chamber 100. Thus, the user can insert the fingers along the inwardly curved and tapered top surface 102 to pick up the aroma capsule 12 from the top accommodation open chamber 100 conveniently. Further, the heat-transfer container 120 defines a rim 1202 around the top opening 1200. The rim 1202 can be configured to extend in a horizontal or vertical manner relative to the elevation of the top opening 1200. Thus, the user can grip the rim 1202 with the fingers to remove the aroma capsule 12 from the accommodation chamber 100 of the heating base 10 of the aroma-diffusing heating device 1 conveniently.

Further, the cap 14 defines a ventilation hole 140 for guiding fragrance out of the absorptive material 123 into the outside open air after removal of the sealing film 124 from the heat-transfer container 120.

When compared to conventional aromatic heating devices, the aroma-diffusing heating device 1 in accordance with the present invention uses a aroma capsule 12 that can be replaced by a new one when used up, and therefore, the user needs not to prepare an extra essential oil container or to worry about breaking down the heat-transfer container, and will not touch the essential oil during replacement of the essential oil.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An aroma-diffusing heating device, comprising:
a heating base defining a top accommodation open chamber;
an aroma capsule detachably accommodated in said top accommodation open chamber and heatable by said heating base to give off fragrance, said aroma capsule comprising a heat-transfer container accommodated in said top accommodation open chamber and kept in contact with the periphery of said top accommodation open chamber, said heat-transfer container defining a top opening, an essential oil held in said heat-transfer container, and an absorptive material put in said heat-transfer container to absorb said essential oil; and
a cap capped on said heating base over said aroma capsule.

2. The aroma-diffusing heating device as claimed in claim 1, said aroma capsule further comprises a sealing film bonded to said heat-transfer container to seal said essential oil and said absorptive material in said heat-transfer container.

3. The aroma-diffusing heating device as claimed in claim 2, said heat-transfer container of said aroma capsule comprises a rim extending around said top opening; said sealing film is bonded to said rim of said heat-transfer container.

4. The aroma-diffusing heating device as claimed in claim 2, said rim of said heat-transfer container extends horizontally in a parallel manner relative to the top opening of said heat-transfer container.

5. The aroma-diffusing heating device as claimed in claim 2, said rim of said heat-transfer container extends in a perpendicular manner relative to the top opening of said heat-transfer container.

6. The aroma-diffusing heating device as claimed in claim 1, said absorptive material is selected from the material group of sponge, ceramics and fibers.

7. The aroma-diffusing heating device as claimed in claim 1, said cap defines therein a ventilation hole.

8. The aroma-diffusing heating device as claimed in claim 1, said heating base comprises an inwardly curved and tapered top surface disposed around said top accommodation open chamber and connected to the periphery of said top accommodation open chamber.

9. An aroma capsule for placing in a top accommodation open chamber of a heating base of an aroma-diffusing heating device and heatable by said heating base to give off fragrance, comprising:
a heat-transfer container defining a top opening;
an essential oil held in said heat-transfer container;
an absorptive material put in said heat-transfer container to absorb said essential oil; and
a sealing film bonded to said heat-transfer container to seal said essential oil and said absorptive material in said heat-transfer container.

10. An aroma capsule for placing in a top accommodation open chamber of a heating base of an aroma-diffusing heating device and heatable by said heating base to give off fragrance, comprising:
a heat-transfer container defining a top opening and a rim around said top opening;
an essential oil held in said heat-transfer container;
an absorptive material put in said heat-transfer container to absorb said essential oil; and
a sealing film bonded to said rim of said heat-transfer container to seal said essential oil and said absorptive material in said heat-transfer container.
